(19) United States
(12) Patent Application Publication
(10) Pub. No.: US 2019/0378532 A1
(43) Pub. Date: Dec. 12, 2019

(54) METHOD AND APPARATUS FOR DYNAMIC MODIFYING OF THE TIMBRE OF THE VOICE BY FREQUENCY SHIFT OF THE FORMANTS OF A SPECTRAL ENVELOPE

(71) Applicants: Centre national de la recherche scientifique, Paris (FR); Sorbonne Université, Paris (FR); INSTITUT DE RECHERCHE ET DE COORDINATION ACOUSTIQUE/MUSIQUE, Paris (FR)

(72) Inventors: Jean-Julien AUCOUTURIER, Besancon (FR); Pablo ARIAS, Paris (FR); Axel ROEBEL, Vitry Sur Seine (FR)

(21) Appl. No.: 16/485,275

(22) PCT Filed: Feb. 12, 2018
(86) PCT No.: PCT/EP2018/053433

§ 371 Date: Aug. 12, 2019

(30) Foreign Application Priority Data
Feb. 13, 2017 (FR) 17 51163

(51) Int. Cl. G10L 21/0332; G10L 25/18; G10L 25/51

(52) U.S. Cl. CPC G10L 21/0332; G10L 25/51; G10L 25/18

(57) ABSTRACT

A method for modifying a sound signal, the method comprising: a step of obtaining time frames of the sound signal, in the frequency domain; for at least one time frame, applying a first transformation of the sound signal in the frequency domain, comprising: a step of extracting a spectral envelope of the sound signal for the at least one time frame; a step of calculating frequencies of formants of the spectral envelope; a step of modifying the spectral envelope of the sound signal, the modification comprising application of an increasing continuous transformation function of frequencies of the spectral envelope, parameterized by at least two frequencies of formants of the spectral envelope.

### FIELD OF THE INVENTION

The present invention relates to the field of acoustic processing. More specifically, the present invention relates to modifying acoustic signals containing speech, in order to give a timbre, for example a smiling timbre to the voice.

### BACKGROUND OF THE INVENTION

Smiling changes the sound of our voice recognizably, to the point that customer service departments advise their representatives to smile on the telephone. Even though customers do not see the smile, it positively affects customer satisfaction.

The study of the characteristics of a sound signal associated with the smiling voice is a new area of study that is not yet well documented. Smiling, using the zygomatic muscles, changes the shape of the mouth cavity, which affects the spectrum of the voice. It has in particular been established that the sound spectrum of the voice is oriented toward higher frequencies when a speaker smiles, and lower frequencies when a voice is sad.

The document Quené H., Semin, G. R., & Foroni, F. (2012). Audible smiles and frowns affect speech comprehension. Speech Communication, 54(7), 917-922 describes a smiling voice simulation test. This experiment consists of recording a word, pronounced neutrally by an experimenter. The experiment is based on the relationship between the frequency of the formants and the timbre of the voice. The formants of a speech sound are the energy maxima of the sound spectrum of the speech. The Quené experiment consists of analyzing the formants of the voice when it pronounces the word, storing their frequencies, producing modified formants by increasing the frequencies of the initial formants by 10%, then re-synthesizing a word with the modified formants.

The Quené experiment makes it possible to obtain words perceived as having been pronounced while smiling. However, the synthesized word has a timbre that will be perceived as artificial by a user.

Furthermore, the two-step architecture proposed by Quené requires analyzing a portion of the signal before being able to re-synthesize it, and therefore causes a time shift between the moment where the word is pronounced and the moment where its transformation can be broadcast. The Quené method therefore does not make it possible to modify a voice in real time.

The modification of the voice in real time has many interesting applications. For example, a real-time modification of the voice can be applied to call center applications: the operator's voice can be modified in real time before being transmitted to a customer, in order to appear more smiling. Thus, the customer will have the sensation that his representative is smiling at him, which is likely to improve customer satisfaction.

Another application is the modification of nonplayer character voices in video games. Nonplayer characters are all of the characters, often secondary, that are controlled by the computer. These characters are often associated with different responses to be stated, which allow the player to advance in the plot of a video game. These responses are typically stored in the form of audio files that are read when the player interacts with the nonplayer characters. It is interesting, from a single neutral audio file, to apply different filters to the neutral voice, in order to produce a timbre, for example smiling or tense, in order to simulate an emotion of the nonplayer character, and enhance the sensation of immersion in the game.

There is therefore a need for a method to modify a timbre of a voice that is simple enough to be executed in real time with the current computing capabilities, and for which the modified voice is perceived as being a natural voice.

### BRIEF DESCRIPTION OF THE INVENTION

To that end, the invention describes a method for modifying a sound signal, said method comprising: a step of obtaining time frames of the sound signal, in the frequency domain; for at least one time frame, applying a first transformation of the sound signal in the frequency domain, comprising: a step of extracting a spectral envelope of the sound signal for said at least one time frame; a step of calculating frequencies of formants of said spectral envelope; a step of modifying the spectral envelope of the sound signal, said modification comprising application of an increasing continuous transformation function of frequencies of the spectral envelope, parameterized by at least two frequencies of formants of the spectral envelope.

Advantageously, the step of modifying the spectral envelope of the sound signal also comprises the application of a filter to the spectral envelope, said filter being parameterized by the frequency of a third formant of the spectral envelope of the sound signal.

Advantageously, the method comprises a step for classifying a time frame, according to a set of time frame classes comprising at least one class of voiced frames and one class of non-voiced frames.

Advantageously, the method comprises: for each voiced frame, the application of said first transformation to the sound signal in the frequency domain; for each non-voiced frame, the application of a second transformation of the sound signal in the frequency domain, said second transformation comprising a step for application of a filter to increase the energy of the sound signal centered on a predefined frequency.

Advantageously, the second transformation of the sound signal comprises: the step of extracting a spectral envelope of the sound signal for said at least one time frame; an application of an increasing continuous transformation function of the frequencies of the spectral envelope, parameterized identically to an increasing continuous transformation function of the frequencies of the spectral envelope for an immediately preceding time frame.

Advantageously, the application of an increasing continuous transformation function of the frequencies of the spectral envelope comprises: a calculation, for a set of initial frequencies determined from formants of the spectral envelope, modified frequencies; a linear interpolation between the initial frequencies of the set of initial frequencies determined from formants of the spectral envelope and the modified frequencies.

Advantageously, at least one modified frequency is obtained by multiplying an initial frequency from the set of initial frequencies by a multiplier coefficient.

Advantageously, the set of frequencies determined from formants of the spectral envelope comprises: a first initial frequency calculated from half of the frequency of a first formant of the spectral envelope of the sound signal; a second initial frequency calculated from the frequency of the second formant of the spectral envelope of the sound signal; a third initial frequency calculated from the frequency of a third formant of the spectral envelope of the sound signal; a fourth initial frequency calculated from the frequency of a fourth formant of the spectral envelope of the sound signal; a fifth initial frequency calculated from the frequency of a fifth formant of the spectral envelope of the sound signal.

Advantageously: a first modified frequency is calculated as being equal to the first initial frequency; a second modified frequency is calculated by multiplying the second initial frequency by the multiplier coefficient; a third modified frequency is calculated by multiplying the third initial frequency by the multiplier coefficient; a fourth modified frequency is calculated by multiplying the fourth initial frequency by the multiplier coefficient; a fifth modified frequency is calculated as being equal to the fifth initial frequency.

Advantageously, each initial frequency is calculated from the frequency of a formant of a current time frame.

Advantageously, each initial frequency is calculated from the average of the frequencies of formants of equal rank, for a number greater than or equal to two successive time frames.

Advantageously, the method is a method for modifying an audio signal comprising a voice in real time, comprising: receiving audio samples; creating a time frame of audio samples, when a sufficient number of samples is available to form said frame; applying a frequency transformation to the audio samples of said frame; applying the first transformation of the sound signal to at least one time frame in the frequency domain.

The invention also describes a method for the application of a smiling timbre to a voice, implementing a method for modifying a sound signal according to the invention, said at least two frequencies of formants being frequencies of formants affected by the smiling timbre of a voice.

Advantageously, said increasing continuous transformation function of the frequencies of the spectral envelope has been determined during a training phase, by comparing spectral envelopes of phenomena stated by users, neutrally or while smiling.

The invention also describes a computer program product comprising program code instructions recorded on a computer-readable medium in order to carry out the steps of the method when said program operates on a computer.

The invention makes it possible to modify a voice in real time to affect it with a timbre, for example a smiling or tense timbre.

The inventive method is not very complex, and can be carried out in real time with ordinary computing capabilities.

The invention introduces a minimal delay between the initial voice and the modified voice.

The invention produces voices perceived as natural.

The invention can be implemented on most platforms, using different programming languages.

### LIST OF FIGURES

Other features will appear upon reading the detailed description provided as a non-limiting example below in light of the appended drawings, which show:

FIG. 1, an example of spectral envelopes, for the vowel ‘a’, stated by an experimenter with and without smiling;

FIG. 2 is an example of a system implementing the invention;

FIGS. 3a and 3b are two exemplary methods according to the invention;

FIGS. 4a and 4b are two examples of continuous increasing transformation functions of the frequencies of the spectral envelope of a time frame according to the invention;

FIGS. 5a, 5b and 5c are three examples of spectral envelopes of vowels modified according to the invention;

FIGS. 6a, 6b and 6c are three examples of spectrograms of phonemes pronounced with and without smiling;

FIG. 7 is an example of vowel spectrogram transformation according to the invention;

FIG. 8 shows three examples of vowel spectrogram transformation according to 3 exemplary embodiments of the invention.

### DETAILED DESCRIPTION OF THE INVENTION

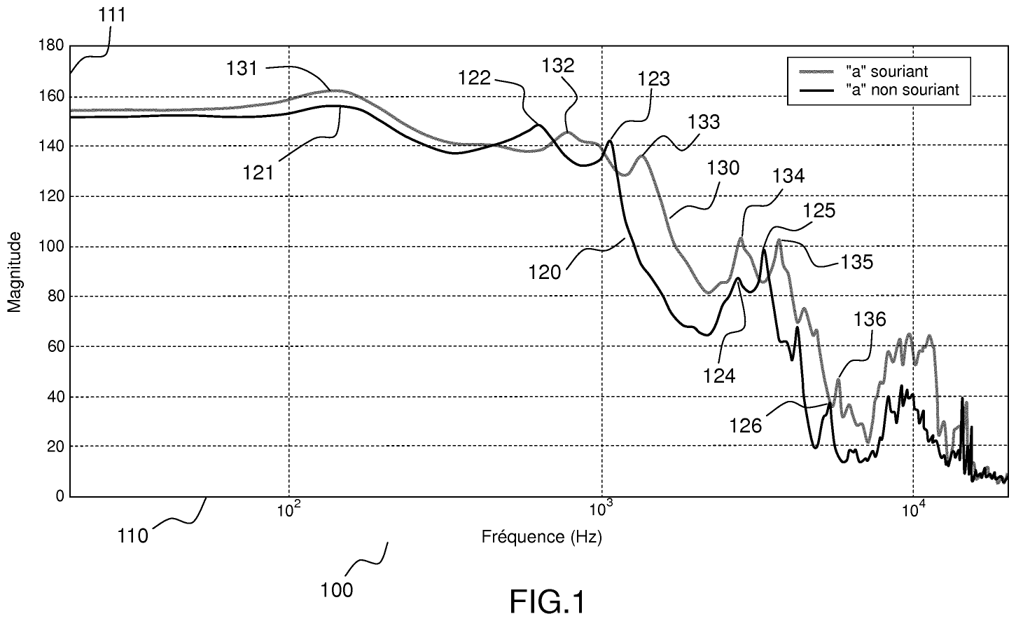

FIG. 1 shows an example of spectral envelopes, for the vowel ‘a’, stated by an experimenter with and without smiling.

The graph 100 shows two spectral envelopes: the spectral envelope 120 shows the spectral envelope of the vowel ‘a’, pronounced by an experimenter without smiling; the spectral envelope 130 shows the same vowel ‘a’, said by the same experimenter, but while smiling. The two spectral envelopes 120 and 130 show an interpolation of the peaks of the Fourier spectrum of the sound: the horizontal axis 110 represents the frequency, using a logarithmic scale; the vertical axis 111 represents the magnitude of the sound at a given frequency.

The spectral envelope 120 comprises a fundamental frequency F0 121, and several formants, including a first formant F1 122, a second formant F2 123, a third formant F3 124, a fourth formant F4 125 and a fifth formant F5 126.

The spectral envelope 130 comprises a fundamental frequency F0 131, and several formants, including a first formant F1 132, a second formant F2 133, a third formant F3 134, a fourth formant F4 135 and a fifth formant F5 136.

It can be noted that although the overall appearance of the two spectral envelopes is identical (which makes it possible to recognize the same ‘a’ phenomenon when the user pronounces this phoneme with or without smiling), smiling affects the frequencies of the formants. Indeed, the frequencies of the first formant F1 132, second formant F2 133, third formant F3 134, fourth formant F4 135 and fifth formant F5 136 for the spectral envelope 130 of the phoneme pronounced while smiling are respectively higher than the frequencies of the first formant F1 122, second formant F2 123, third formant F3 124, fourth formant F4 125, fifth formant F5 126 for the spectral envelope 120 of the phoneme pronounced neutrally. On the contrary, the fundamental frequencies F0 121 and 131 are the same for both spectral envelopes.

In parallel, the spectral envelope of the smiling voice also has a greater intensity around the frequency of the third formant F3 134.

These differences allow the listener both to recognize the pronounced phoneme, and to recognize how it was pronounced (neutrally or while smiling).

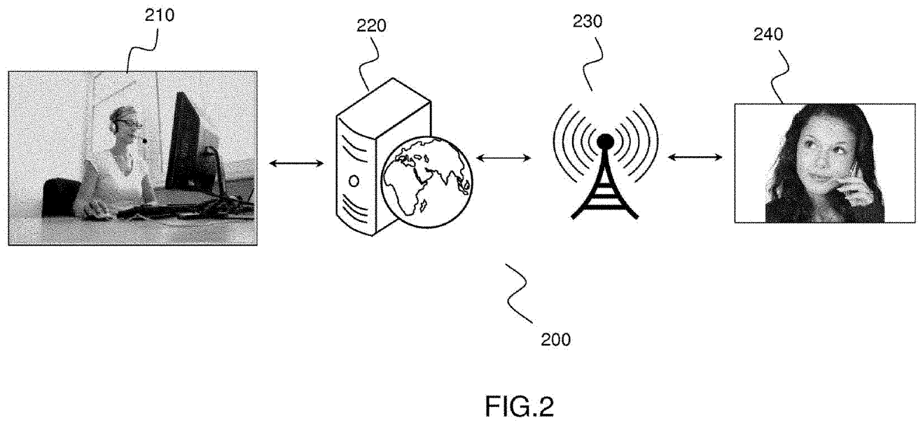

FIG. 2 shows an example of a system implementing the invention.

The system 200 shows an exemplary embodiment of the invention, in the case of a connection between a user 240 and a call center agent 210. In this example, the call center agent 210 communicates using an audio headset equipped with a microphone, connected to a workstation. This workstation is connected to a server 220, which can for example be used for a whole call center, or a group of call center agents. The server 220 communicates, by means of a communication link, with a relay antenna 230, allowing a radio link with a mobile telephone of the user 240.

This system is given solely as an example, and other architectures can be set up. For example, the user 240 can use a landline telephone. The call center agent can also use a telephone, connected to the server 220. The invention can thus be applied to all system architectures allowing a connection between a user and a call center agent, comprising at least a server or a workstation.

The call center agent 210 generally speaks in a neutral voice. A method according to the invention can thus be applied, for example by the server 220 or the workstation of the call center agent 210, to modify the sound of the call center agent's voice in real time, and to send the client 240 a modified voice, appearing naturally smiling. Thus, the customer's sensation regarding the interaction with the call center agent is improved as a result. In return, the customer can also respond cheerfully to a voice appearing to him to be smiling, which contributes to an overall improvement in the interaction between the customer 240 and the call center agent 210.

The invention is not, however, limited to this example. It can for example be used for a real-time modification of neutral voices. For example, it can be used to give a timbre (tense, smiling, etc.) to a neutral voice of a Non-Player Character of a video game, in order to give a player the sensation that the Non-Player Character is feeling an emotion. It can be used, based on the same principle, for real-time modifying of sentences stated by a humanoid robot, in order to give the user of the humanoid robot the sensation that the latter is experiencing a feeling, and to improve the interaction between the user and the humanoid robot. The invention can also be applied to the voices of players for online video games, or for therapeutic purposes, for real-time modification of the patient's voice, in order to improve the emotional state of the patient, by giving him the impression that he is speaking in a smiling voice.

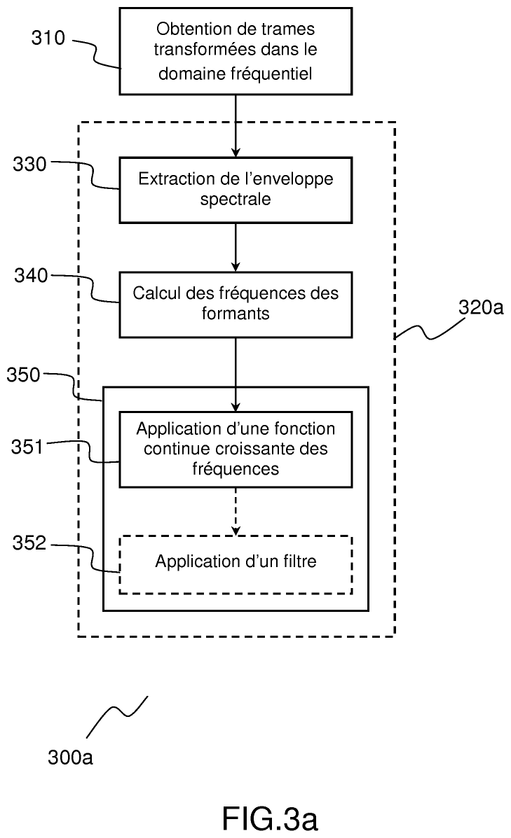

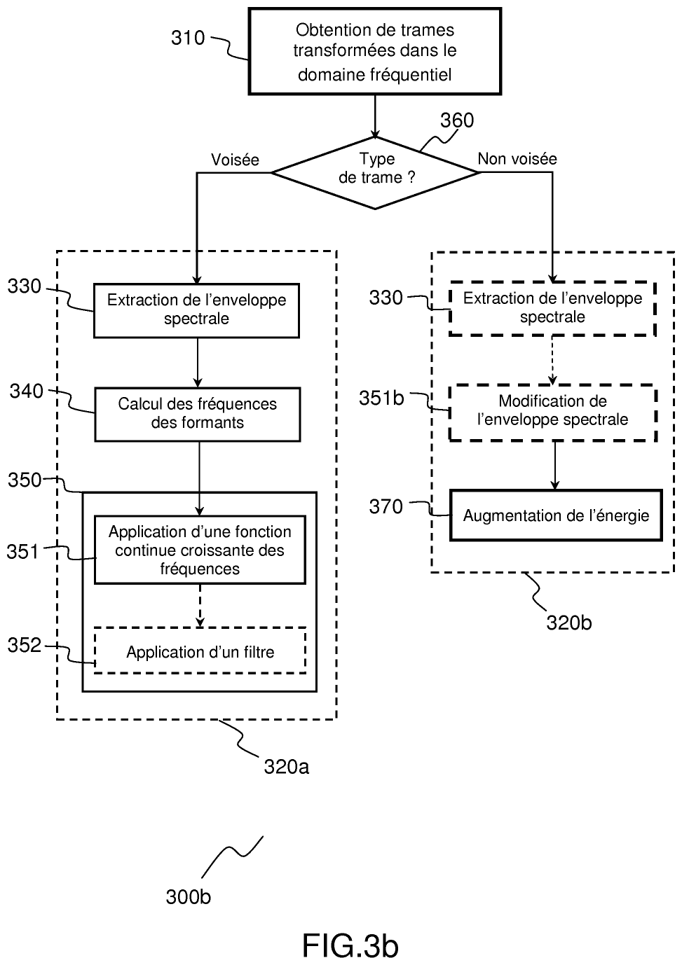

FIGS. 3a and 3b show two exemplary methods according to the invention.

FIG. 3a shows a first exemplary method according to the invention.

The method 300a is a method for modifying a sound signal, and can for example be used to assign an emotion to a voice track pronounced neutrally. The emotion can consist of making the voice more smiling, but can also consist of making the voice less smiling, more tense, or assigning it intermediate emotional states.

The method 300a comprises a step for obtaining 310 time frames of the sound signal, and transforming them in the frequency domain. The step 310 consists of obtaining successive time frames forming the sound signal.

The audio frames can be obtained in different ways. For example, they can be obtained by recording an operator speaking into a microphone, reading an audio file, or receiving audio data, for example through a connection.

According to different embodiments of the invention, the time frames can be of fixed or variable duration. For example, the time frames can have the shortest possible duration allowing a good spectral analysis, for example 25 or 50 ms. This duration advantageously makes it possible to obtain a sound signal to be representative of a phoneme, while limiting the lag generated by the modification of the sound signal.

According to different embodiments of the invention, the sound signal can be of different types. For example, it can be a mono signal, stereo signal, or a signal comprising more than two channels. The method 300a can be applied to all or some of the channels of the signal. Likewise, the signal can be sampled according to different frequencies, for example 16000 Hz, 22050 Hz, 32000 Hz, 44100 Hz, 48000 Hz, 88200 Hz or 96000 Hz. The samples can be represented in different ways. For example, these can be sound samples represented over 8, 12, 16, 24 or 32 bits. The invention can thus be applied to any type of computer representation of a sound signal.

According to different embodiments of the invention, the time frames can be obtained either directly in the form of their frequency transform, or acquired in the time domain and transformed in the frequency domain.

They can for example be obtained directly in the frequency domain if the sound signal is initially stored or transmitted using a compressed audio format, for example according to the MP3 format (or MPEG-1/2 Audio Layer 3, acronym for Motion Picture Expert Group—½ Audio Layer 3), AAC (acronym for Advanced Audio Coding), WMA (acronym for Windows Media Audio), or any other compression format in which the audio signal is stored in the frequency domain.

The frames can also be obtained first in the time domain, then converted into the frequency domain. For example, a sound can be recorded directly using a microphone, for example a microphone in which the call center operator 210 speaks. The time frames are then first formed by storing a given number of successive samples (defined by the duration of the frame and the sampling frequency of the sound signal), then by applying a frequency transformation of the sound signal. The frequency transformation can for example be a transformation of type DFT (Direct Fourier Transform), DCT (Direct Cosine Transform), MDCT (Modified Direct Cosine Transform), or any other appropriate transformation making it possible to convert the sound samples from the time domain to the frequency domain.

The method 300a next comprises, for at least one time frame, the application of a first transformation 320a of the sound signal to the frequency domain.

The first transformation 320a comprises a step of extracting 330 the spectral envelope of the sound signal for said at least one frame. The extraction of the spectral envelope of the sound signal from the frequency transform of a frame is well known by one skilled in the art. The frequency transform can be done in many ways known by one skilled in the art. The frequency transform can for example be done by linear predictive encoding, as for example described by Makhoul, J. (1975). Linear prediction: A tutorial review. Proceedings of the IEEE, 63(4), 561-580. The frequency transform can also be done for example by cepstral transform, as for example described by Röbel, A., Villavicencio, F., & Rodet, X. (2007). On cepstral and all-pole based spectral envelope modeling with unknown model order. Pattern Recognition Letters, 28(11), 1343-1350. Any other frequency transformation method known by one skilled in the art can also be used.

The first transformation 300a also comprises a step for calculating 340 frequencies of formants of said spectral envelope. Many methods for extracting formants can be used in the invention. The calculation of the frequencies of formants of the spectral envelope can for example be done using the method described by McCandless, S. (1974). An algorithm for automatic formant extraction using linear prediction spectra. IEEE Transactions on Acoustics, Speech, and Signal Processing, 22(2), 135-141.

The method 300a also comprises a step for modifying 350 the spectral envelope of the sound signal. Modifying the spectral envelope of the sound signal makes it possible to obtain a spectral envelope that is more representative of the desired emotion.

The step for modifying 350 the spectral envelope comprises the application 351 of a continuous increasing transformation function of the frequencies of the spectral envelope, parameterized by at least two frequencies of formants of the spectral envelope.

Using a continuous increasing transformation function to modify the frequencies of the spectral envelope makes it possible to modify the spectral envelope without creating a discontinuity between successive frequencies. Furthermore, the parameterization of the continuous increasing transformation function by at least two frequencies of formants makes it possible to affect a continuous transformation of the spectral envelope at the part of the spectrum, defined by the frequencies of certain formants, affected by a given emotion.

In one embodiment of the invention, the step of modifying 350 the spectral envelope of the sound signal also comprises the application 352 of a dynamic filter to the spectral envelope, said filter being parameterized by the frequency of a third formant F3 of the spectral envelope of the sound signal.

This step makes it possible to increase or reduce the intensity of the signal around the frequency of the third formant F3 of the spectral envelope of the sound signal, so that the modified spectral envelope is even closer to that of a phoneme emitted with the desired emotion. For example, as shown in FIG. 1, an increase in the sound intensity around the frequency of the third formant F3 of the spectral envelope of the sound signal makes it possible to obtain a spectral envelope even closer to what would be the spectral envelope of a same phoneme stated while smiling.

According to different embodiments of the invention, the filter used in this step can be of different types. For example, the filter can be a bi-quad filter with a gain of 8 dB, Q=1.2, centered on the frequency of the third formant F3. This filter makes it possible to increase the intensity of the spectrum for frequencies around that of the formant F3, and thus to obtain a spectral envelope closer to that which would have been obtained by a smiling speaker.

Once the spectral envelope is modified, the spectral envelope can be applied to the sound spectrum. Many other embodiments are possible to apply the spectral envelope to the sound spectrum. For example, it is possible to multiply each of the components of the spectrum by the corresponding value of the envelope, as for example described by Luini M. et al. (2013). Phase vocoder and beyond. Musica/Tenologia, August 2013, Vol. 7, no. 2013, p. 77-89.

Once the sound spectrum is reconstituted, different treatments can be applied to the frame, according to different embodiments of the invention. In certain embodiments of the invention, a reverse frequency transform can be applied directly to the sound frame, in order to reconstruct the audio signal and listen to it directly. This for example makes it possible to listen to a modified nonplayer character voice of a video game.

It is also possible to transmit the modified sound signal, so that it is listened to by a third-party user. This is for example the case for embodiments relative to call-center operator call centers. In this case, the sound signal can be sent in raw or compressed form, in the frequency domain or in the time domain.

In some embodiments of the invention, the method 300a can be used to modify an audio signal comprising a voice in real time, in order to allocate an emotion to a neutral voice. This real-time modification can for example be done by:
receiving audio samples, for example recorded in real time by a microphone;
creating a time frame of audio samples, when a sufficient number of samples is available to form said frame;
applying a frequency transformation to the audio samples of said frame;
applying the first transformation 320a of the sound signal to at least one transformed frame in the frequency domain.

This method makes it possible to apply an expression to a neutral voice in real time. The step for creating the frame (or windowing) includes a lag in the performance of the method, since the audio samples can only be treated when all of the samples of the frame are received. However, this lag depends solely on the duration of the time frames, and can be small, for example if the time frames have a duration of 50 ms.

The invention also relates to a computer program product comprising program code instructions recorded on a computer-readable medium in order to carry out the method 300a, or any other method according to different embodiments of the invention, when said program operates on a computer. Said computer program can for example be stored and/or run on the workstation of the call center operator 210, or on the server 220.

FIG. 3b shows a second exemplary method according to the invention.

The method 300b is also a method for modifying a sound signal, making it possible to process the time frames differently depending on the type of information that they contain.

To that end, the method 300b comprises a step for classifying 360 a time frame, according to a set of time frame classes comprising at least one class of voiced frames and one class of non-voiced frames.

This step makes it possible to associate each frame with a class, and to adapt the processing of the frame depending on the class to which it belongs. A time frame can for example belong to a class of voiced frames it comprises a vowel, and a class of non-voiced frames if it does not comprise a vowel, for example if it comprises a consonant. Different methods exist for determining the voiced or non-voiced nature of a time frame. For example, the ZCR (acronym for Zero Crossing Rate) of the frame can be calculated, and compared to a threshold. If the ZCR is below the threshold, the frame will be considered non-voiced, otherwise voiced.

The method 300b comprises, for each voiced frame, the application of the first transformation 320a of the sound signal in the frequency domain. All of the embodiments of the invention discussed in reference to FIG. 3a can be applied to the first transformation 320a in the context of the method 300b.

The method 300b comprises, for each non-voiced frame, the application of a second transformation 320b of the sound signal in the frequency domain.

The second transformation 320b of the sound signal in the frequency domain comprises a step for applying a filter to increase the energy of the sound signal 370 centered on a frequency, for example a predefined frequency. In one embodiment, this filter is a bi-quad filter with a gain of 8 dB, Q=1, centered on a frequency in the high-medium/acute, for example 6000 Hz.

This feature makes it possible to refine the transformation of the audio signal by applying a transformation on non-voiced frames, for which the spectral envelope does not have a formant.

In one embodiment of the invention, the second transformation 320b of the sound signal also comprises step 330 for extracting a spectral envelope of the sound signal, for the frame in question, and a step for applying 351b a continuous increasing transformation function of the frequencies of the spectral envelope.

The step 351b for applying an increasing continuous transformation function of the frequencies of the spectral envelope is parameterized identically to an increasing continuous transformation function of the frequencies of the spectral envelope for an immediately preceding time frame. Thus, in this embodiment of the invention, if a voiced frame is immediately followed by a non-voiced frame, a continuous increasing transformation function of the frequencies of the envelope is parameterized according to the frequencies of formants of the spectral envelope of the voiced frame, then is applied according to the same parameters to the immediately following non-voiced frame. If several non-voiced frames follow the voiced frame, the same transformation function, according to the same parameters, can be applied to the successive non-voiced frames.

This feature makes it possible to apply a transformation function of the frequencies of the spectral envelope of the non-voiced frames, even if these do not comprise formants, while benefiting from a transformation that is as coherent as possible with the preceding voiced frames.

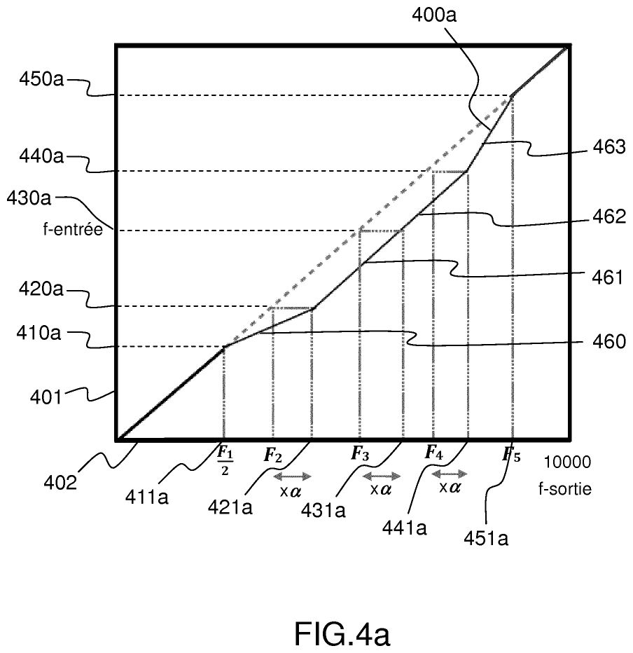

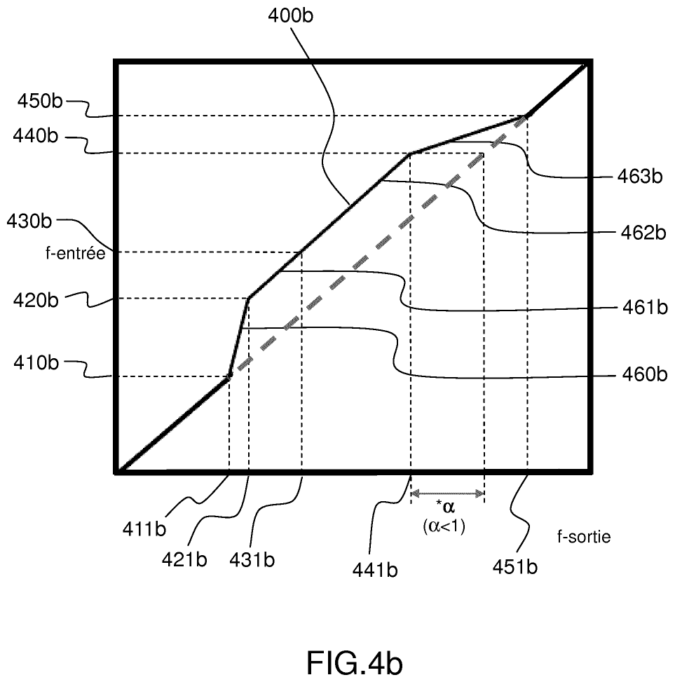

FIGS. 4a and 4b show two examples of continuous increasing transformation functions of the frequencies of the spectral envelope of a time frame according to the invention.

FIG. 4a shows a first example continuous increasing transformation function of the frequencies of the spectral envelope of a time frame according to the invention.

The function 400a defines the frequencies of the modified spectral envelope, shown on the x-axis 401, as a function of the frequencies of the initial spectral envelope, shown on the y-axis 402. This function thus makes it possible to build the modified spectral envelope as follows: the intensity of each frequency of the modified spectral envelope is equal to the intensity of the frequency of the initial spectral envelope indicated by the function. For example, the intensity for the frequency 411a of the modified spectral envelope is equal to the intensity for the frequency 410a of the initial spectral envelope.

In one set of embodiments of the invention, the transformation function of the frequencies is defined as follows:
A modified frequency is calculated for each initial frequency of a set of initial frequencies. In the example of the function 400a, the modified frequencies 411a, 421a, 431a, 441a and 451a are calculated respectively corresponding to the initial frequencies 410a, 420a, 430a, 440a and 450a;
Next, linear interpolations are done between the initial frequencies of the set of initial frequencies determined from formants of the spectral envelope and the modified frequencies. For example, the linear interpolation 460 makes it possible to define linearly, for each initial frequency between the first initial frequency 410a and the second initial frequency 420a, a modified frequency, between the first modified frequency 411a and the second modified frequency 421a.

Similarly:
The linear interpolation 461 makes it possible to define linearly, for each initial frequency between the second initial frequency 420a and the third initial frequency 430a, a modified frequency, between the second modified frequency 421a and the third modified frequency 431a;
The linear interpolation 462 makes it possible to define linearly, for each initial frequency between the third initial frequency 430a and the fourth initial frequency 440a, a modified frequency, between the third modified frequency 431a and the fourth modified frequency 441a;
The linear interpolation 463 makes it possible to define linearly, for each initial frequency between the fourth initial frequency 440a and the fifth initial frequency 450a, a modified frequency, between the fourth modified frequency 441a and the fifth modified frequency 451a.

The modified frequencies can be calculated in different ways. Some of them can be equal to the initial frequencies. Some can for example be obtained by multiplying an initial frequency by a multiplier coefficient α. This makes it possible, depending on whether the multiplier coefficient α is greater than or less than one, to obtain modified frequencies higher or lower than the initial frequencies. In general, a modified frequency higher than the corresponding initial frequency (α>1) is associated with a more joyful or smiling voice, while a modified frequency lower than the corresponding initial voice (α<1) is associated with a tenser, or less smiling, voice. In general, the further the value of the multiplier coefficient α is from 1, the more pronounced the applied effect will be. Thus, the values of the coefficient α make it possible to define the transformation to be applied to the voice, but also the significance of this transformation.

In one set of embodiments of the invention, the initial frequencies to parameterize the transformation function are the following:
a first initial frequency (410a) calculated from half of the frequency of a first formant (F1) of the spectral envelope of the sound signal;
a second initial frequency (420a) calculated from the frequency of a second formant (F2) of the spectral envelope of the sound signal;
a third initial frequency (430a) calculated from the frequency of a third formant (F3) of the spectral envelope of the sound signal;
a fourth initial frequency (440a) calculated from the frequency of a fourth formant (F4) of the spectral envelope of the sound signal;
a fifth initial frequency (450a) calculated from the frequency of a fifth formant (F5) of the spectral envelope of the sound signal.

The frequencies of the spectral envelope lower than the first initial frequency 410a, and higher than the fifth initial frequency 450a, are thus not modified. This makes it possible to restrict the transformation of the frequencies to the frequencies corresponding to the formants affected by the tense or smiling timbre of the voice, and for example not modifying the fundamental frequency F0.

In one embodiment of the invention, the initial frequencies correspond to the frequencies of the formants of the current time frame. Thus, the parameters of the transformation function are modified for each time frame.

The initial frequencies can also be calculated as the average of the frequencies of formants of equal rank, for a number greater than or equal to two successive time frames. For example, the first initial frequency 410a can be calculated as the average of the frequencies of the first formants F1 for the spectral envelopes of n successive time frames, with n≥2.

In a set of embodiments of the invention, the frequency transformation is primarily applied between the second formant F2 and the fourth formant F4. The modified frequencies can thus be calculated as follows:
a first modified frequency 411a is calculated as being equal to the first initial frequency 410a;
a second modified frequency 421a is calculated by multiplying the second initial frequency 420a by the multiplier coefficient α;
a third modified frequency 431a is calculated by multiplying the third initial frequency 430a by the multiplier coefficient α;
a fourth modified frequency 441a is calculated by multiplying the fourth initial frequency 440a by the multiplier coefficient α;
a fifth modified frequency 451a is calculated as being equal to the fifth initial frequency 450a.

The example transformation function 400a makes it possible to transform the spectral envelope of a time frame to obtain a more smiling voice, owing to higher frequencies, in particular between the second formant F2 and the fourth formant F4.

In one embodiment, the multiplier coefficient α is predefined. For example, the multiplier coefficient α can be equal to 1.1 (10% increase of the frequencies).

In some embodiments of the invention, the multiplier coefficient α can depend on the modification intensity of the voice to be generated.

In some embodiments of the invention, the multiplier coefficient α can also be determined for a given user. For example, it can be determined during a training phase, during which the user pronounces phonemes in a neutral voice, then a smiling voice. Comparing the frequencies of the different formants, for the phonemes pronounced in a neutral voice and a smiling voice, thus makes it possible to calculate a multiplier coefficient α adapted to a given user.

In one set of embodiments of the invention, the value of the coefficient α depends on the phoneme. In these embodiments of the invention, a method according to the invention comprises a step for detecting the current phoneme, and the value of the coefficient α is defined for the current frame. For example, the values of α can have been determined for a given phoneme during a training phase.

FIG. 4b shows a second example continuous increasing transformation function of the frequencies of the spectral envelope of a time frame according to the invention.

FIG. 4b shows a second function 400b, making it possible to give a voice a tenser, or more smiling, timbre.

The illustration of FIG. 4b is identical to that of FIG. 4a: the frequencies of the modified spectral envelope are shown on the x-axis 401, as a function of the frequencies of the initial spectral envelope, shown on the y-axis 402.

The function 400b is also built by calculating, for each initial frequency 410b, 420b, 430b, 440b, 450b, a modified frequency 411b, 421b, 431b, 441b, 451b, then defining linear interpolations 460b, 461b, 462b and 463b between the initial frequencies and the modified frequencies.

In the example of the function 400b, the modified frequencies 411b and 451b are equal to the initial frequencies 410b and 450b, while the modified frequencies 421b, 431b and 441b are obtained by multiplying the initial frequencies 420b, 430b and 440b by a factor α<1. Thus, the frequencies of the second formant F2, third formant F3 and fourth formant F4 of the spectral envelope modified by the function 400b will be more serious than those of the corresponding formants of the initial spectral envelope. This makes it possible to give the voice a tense timbre.

The functions 400a and 400b are given solely as an example. Any continuous increasing function of the frequencies of a spectral envelope, parameterized from frequencies of the formants of the envelope, can be used in the invention. For example, a function defined based on frequencies of formants related to the smiling nature of the voice is particularly suitable for the invention.

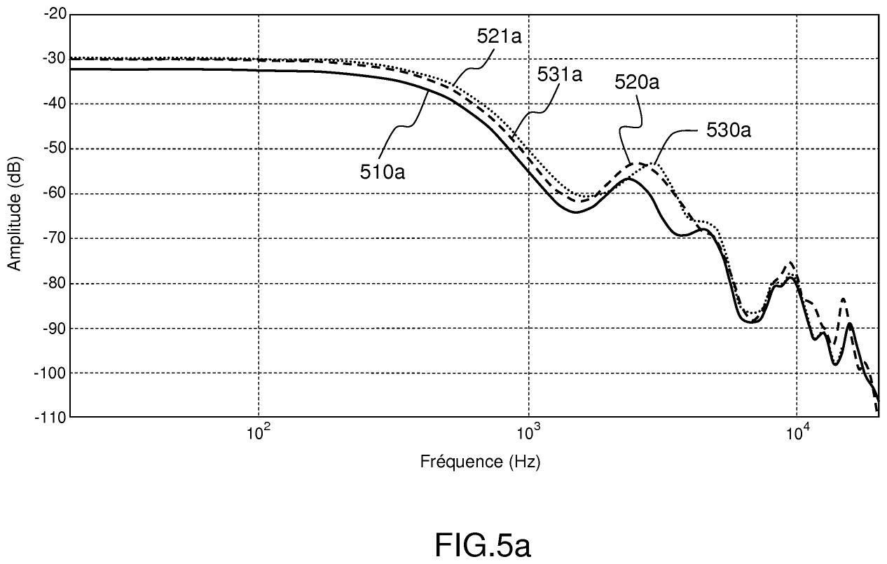

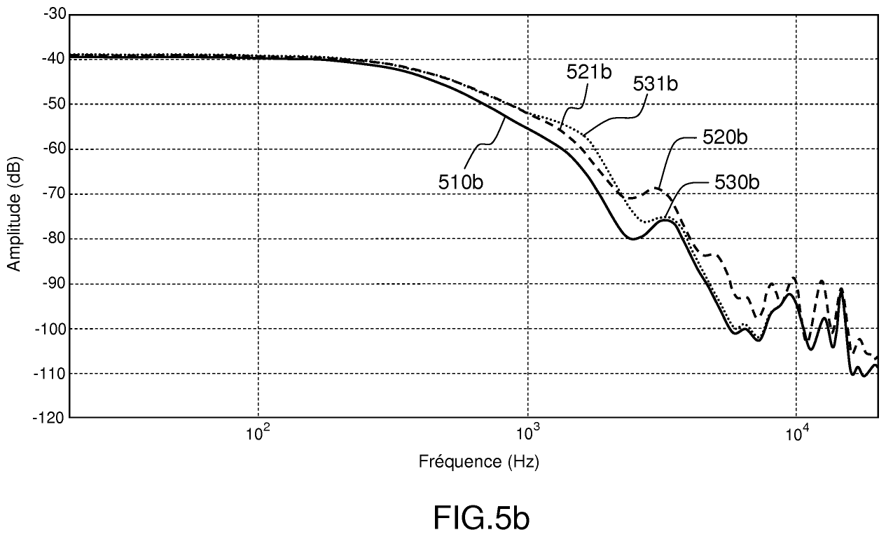

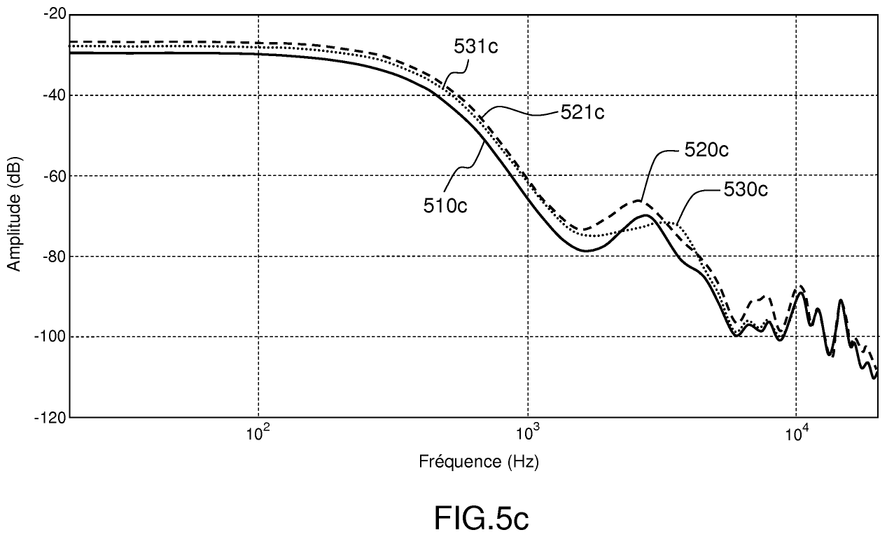

FIGS. 5a, 5b and 5c show three examples of spectral envelopes of vowels modified according to the invention.

FIG. 5a shows the spectral envelope 510a of the phoneme ‘e’, stated neutrally by an experimenter, and the spectral envelope 520a of the same phoneme ‘e’ stated in a smiling manner by the experimenter. FIG. 5a also shows the spectral envelope 530a modified by a method according to the invention in order to make the voice more smiling. The spectral envelope 530a thus shows the result of the application of a method according to the invention to the spectral envelope 510a.

FIG. 5b shows the spectral envelope 510b of the phoneme ‘a’, stated neutrally by an experimenter, and the spectral envelope 520b of the same phoneme ‘a’ stated in a smiling manner by the experimenter. FIG. 5b also shows the spectral envelope 530b modified by a method according to the invention in order to make the voice more smiling. The spectral envelope 530b thus shows the result of the application of a method according to the invention to the spectral envelope 510b.

FIG. 5c shows the spectral envelope 510c of the phoneme ‘e’, stated neutrally by a second experimenter, and the spectral envelope 520c of the same phoneme ‘e’ stated in a smiling manner by the second experimenter. FIG. 5c also shows the spectral envelope 530c modified by a method according to the invention in order to make the voice more smiling. The spectral envelope 530c thus shows the result of the application of a method according to the invention to the spectral envelope 510c.

In this example, the method according to the invention comprises the application of the function 400a for transforming frequencies shown in FIG. 4a, and the application of a bi-quad filter centered on the frequency of the third formant F3 of the envelope.

FIGS. 5a, 5b and 5c show that the method according to the invention makes it possible to retain the overall shape of the envelope of the phoneme, while modifying the position and the amplitude of certain formants, so as to simulate a voice appearing to be smiling, while remaining natural.

It is more particularly noteworthy that the method according to the invention allows the spectral envelope transformed according to the invention to be very similar to a spectral envelope of a smiling voice, for the frequencies of the high medium of the spectrum, as shown by the similarity of curves 521a and 531a; 521b and 531b; 521c and 531c, respectively.

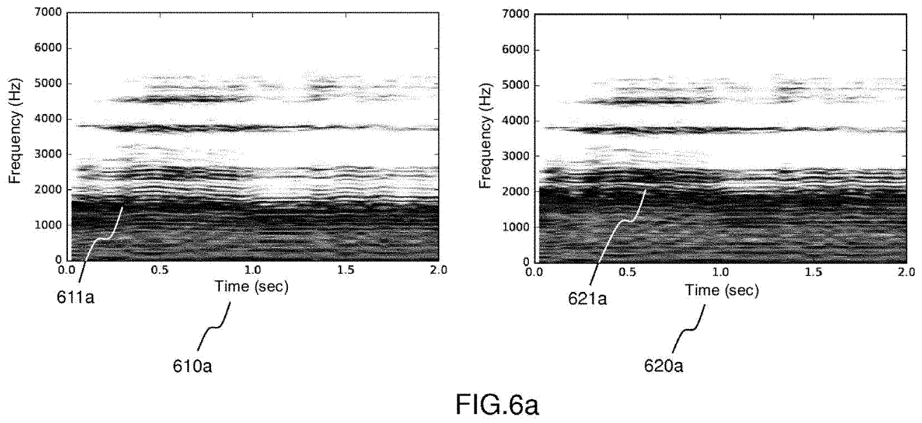

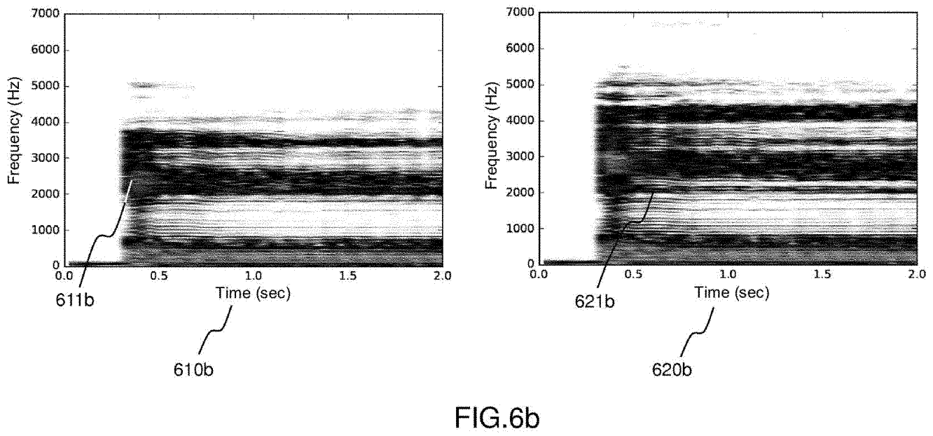

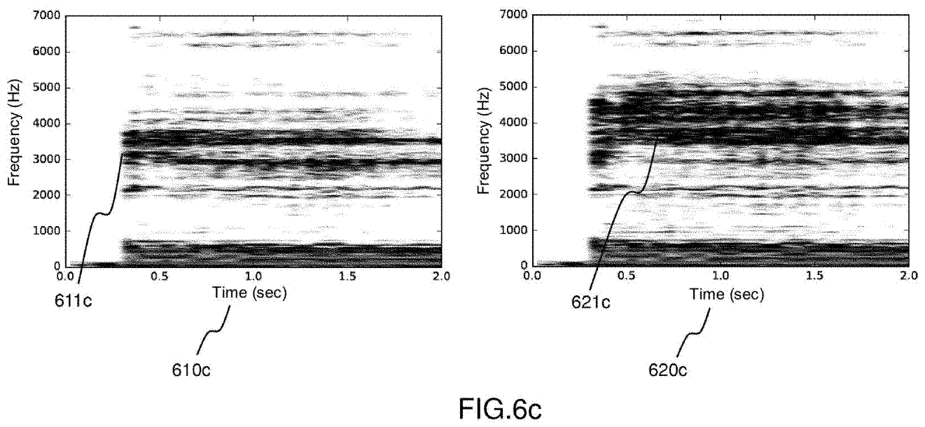

FIGS. 6a, 6b and 6c show three examples of spectrograms of phonemes pronounced with and without smiling.

FIG. 6a shows a spectrograms 610a of an ‘a’ phoneme pronounced neutrally, and a spectrogram 620a of the same ‘a’ phoneme to which the invention has been applied, in order to make the voice more smiling. FIG. 6b shows a spectrograms 610b of an ‘e’ phoneme pronounced neutrally, and a spectrogram 620b of the same ‘e’ phoneme to which the invention has been applied, in order to make the voice more smiling. FIG. 6c shows a spectrograms 610c of an ‘i’ phoneme pronounced neutrally, and a spectrogram 620c of the same ‘i’ phoneme to which the invention has been applied, in order to make the voice more smiling.

Each of the spectrograms shows the evolution over time of the sound intensity for different frequencies, and is read as follows:
The horizontal axis represents time, within the diction of the phoneme;
The vertical axis represents the different frequencies;
The sound intensities are represented, for a given time and frequency, by the corresponding gray level: white represents a nil intensity, while a very dark gray represents a strong intensity of the frequency at the corresponding time.

It is possible to observe, in general, that according to the spectral envelopes shown in FIG. 1, the energy is, in general, increased in the high medium of the spectrum in the case of a smiling voice relative to a neutral voice: one can thus see an increase in the sound intensity in the high medium of the spectrum, as shown between zones 611a and 621a; 611b and 621b; 611c and 621c, respectively.

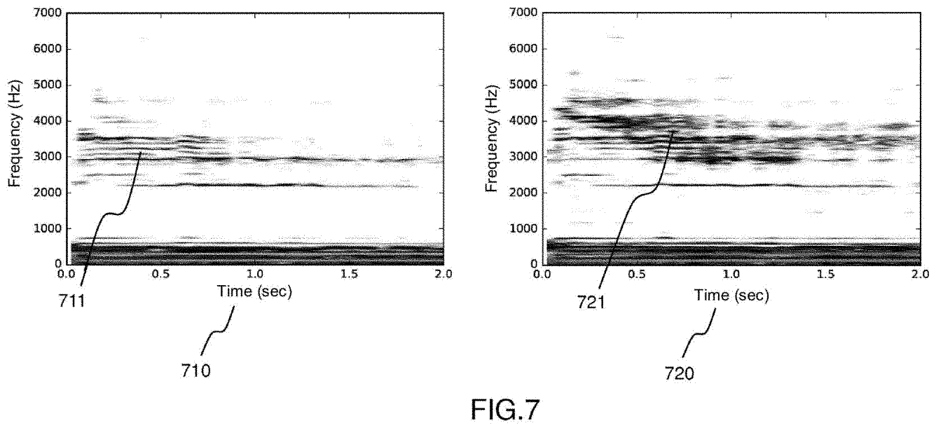

FIG. 7 shows an example of vowel spectrogram transformation according to the invention.

FIG. 7 shows a spectrograms 710 of an ‘i’ phoneme pronounced neutrally, and a spectrogram 720 of the same ‘i’ phoneme to which the invention has been applied, in order to make the voice more smiling.

Each of the spectrograms shows the evolution over time of the intensity for different frequencies, according to the same illustration as that of FIGS. 6a to 6c.

It is possible to observe, in general, that according to the spectral envelopes shown in FIGS. 5a to 5c, the sound intensity is, in general, increased in the high medium of the spectrum: one can thus see an increase in the sound intensity in the high medium of the spectrum, as shown between zones 711 and 721. The smiling voice effect is thus similar to the effect of a real smile as illustrated in FIGS. 6a to 6c.

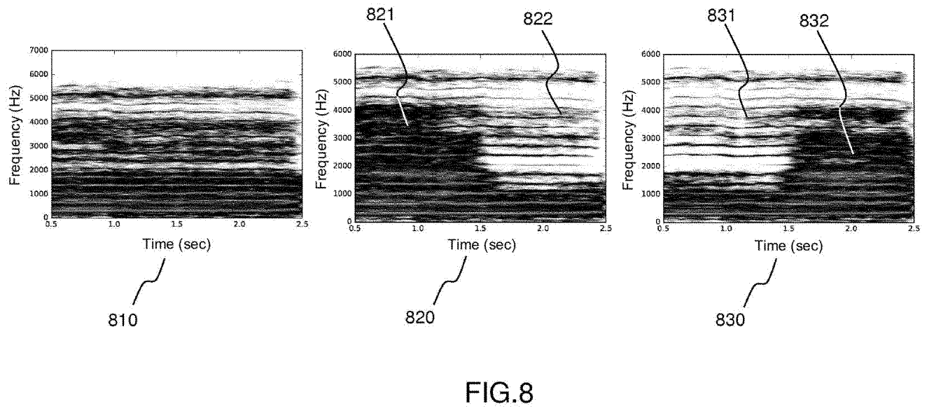

FIG. 8 shows three examples of vowel spectrogram transformation according to 3 exemplary embodiments of the invention.

In one set of embodiments of the invention, the value of the multiplier coefficient α can be modified over time, for example to simulate a gradual modification of the timbre of the voice. For example, the value of the multiplier coefficient α can increase in order to give an impression of an increasingly smiling voice, or decrease in order to give an impression of an increasingly tense voice.

The spectrogram 810 represents a spectrogram of a vowel pronounced with a neutral tone and modified by the invention, with a constant multiplier coefficient α. The spectrogram 820 represents a spectrogram of a vowel pronounced with a neutral tone and modified by the invention, with a decreasing multiplier coefficient α. The spectrogram 830 represents a spectrogram of a vowel pronounced with a neutral tone and modified by the invention, with an increasing multiplier coefficient α.

It is possible to observe that the evolution of the spectrogram modified over time in these different examples is different: in the case of a decreasing multiplier coefficient α, the intensities of the frequencies in the high medium of the spectrum are progressively higher 821, then lower 822. Conversely, in the case of an increasing multiplier coefficient α, the intensities of the frequencies in the high medium of the spectrum are progressively lower 831, then higher 832.

This example demonstrates the ability of a method according to the invention to adjust the transformation of the spectral envelope, in order to produce effects in real time, for example to produce a more or less smiling voice.

The above examples demonstrate the ability of the invention to assign a timbre to a voice with a reasonable calculation complexity, while ensuring that the modified voice appears natural. However, they are only provided as an example and in no case limit the scope of the invention, defined in the claims below.

What is claimed is:

1. A method for modifying a sound signal, said method comprising:
a step of obtaining (310) time frames of the sound signal, in the frequency domain;
for at least one time frame, applying a first transformation (320a) of the sound signal in the frequency domain, comprising:
a step of extracting (330) a spectral envelope of the sound signal for said at least one time frame;
a step of calculating (340) frequencies of formants of said spectral envelope;
a step of modifying (350) the spectral envelope of the sound signal, said modification comprising application (351) of an increasing continuous transformation function of frequencies of the spectral envelope, parameterized by at least two frequencies of formants of the spectral envelope.

2. The method according to claim 1, wherein the step of modifying (350) the spectral envelope of the sound signal also comprises the application (352) of a filter to the spectral envelope, said filter being parameterized by the frequency of a third formant (F3) of the spectral envelope of the sound signal.

3. The method according to claim 1, comprising a step for classifying (360) a time frame, according to a set of time frame classes comprising at least one class of voiced frames and one class of non-voiced frames.

4. The method according to claim 3, comprising:
for each voiced frame, the application of said first transformation (320a) of the sound signal in the frequency domain;
for each non-voiced frame, the application of a second transformation (320b) of the sound signal in the frequency domain, said second transformation comprising a step for application of a filter to increase the energy of the sound signal (370) centered on a predefined frequency.

5. The method according to claim 4, wherein the second transformation (320b) of the sound signal comprises:
the step of extracting (330) a spectral envelope of the sound signal for said at least one time frame;
applying (351b) an increasing continuous transformation function of the frequencies of the spectral envelope parameterized identically to an increasing continuous transformation function of the frequencies of the spectral envelope for an immediately preceding time frame.

6. The method according claim 1, wherein the application (351) of an increasing continuous transformation function of the frequencies of the spectral envelope comprises:
a calculation, for a set of initial frequencies (410, 420, 430, 440, 450) determined from formants of the spectral envelope, modified frequencies (410a, 420a, 430a, 440a, 450a);
a linear interpolation (460, 461, 462, 463) between the initial frequencies of the set of initial frequencies determined from formants of the spectral envelope and the modified frequencies.

7. The method according to claim 5, wherein at least one modified frequency (420a, 430a, 440a) is obtained by multiplying an initial frequency (420, 430, 440) from the set of initial frequencies by a multiplier coefficient (α).

8. The method according to claim 7, wherein the set of frequencies determined from formants of the spectral envelope comprises:
a first initial frequency (410) calculated from half of the frequency of a first formant (F1) of the spectral envelope of the sound signal;
a second initial frequency (420) calculated from the frequency of a second formant (F2) of the spectral envelope of the sound signal;
a third initial frequency (430) calculated from the frequency of a third formant (F3) of the spectral envelope of the sound signal;
a fourth initial frequency (440) calculated from the frequency of a fourth formant (F4) of the spectral envelope of the sound signal;
a fifth initial frequency (450) calculated from the frequency of a fifth formant (F5) of the spectral envelope of the sound signal.

9. Method according to claim 8, wherein:
a first modified frequency (410a) is calculated as being equal to the first initial frequency (410);
a second modified frequency (420a) is calculated by multiplying the second initial frequency (420) by the multiplier coefficient (α);
a third modified frequency (430a) is calculated by multiplying the third initial frequency (430) by the multiplier coefficient (α);
a fourth modified frequency (440a) is calculated by multiplying the fourth initial frequency (440) by the multiplier coefficient (α);
a fifth modified frequency (450a) is calculated as being equal to the fifth initial frequency (450).

10. The method according to claim 8, wherein each initial frequency is calculated from the frequency of a formant of a current time frame.

11. The method according to claim 8, wherein each initial frequency is calculated from the average of the frequencies of formants of equal rank, for a number greater than or equal to two successive time frames.

12. The method according to claim 1, said method being suitable for modifying the sound signal in real time, and wherein:
the sound signal comprises a voice;
the step of obtaining (310) time frames of the sound signal in the frequency domain comprises:
receiving audio samples;
creating a time frame of audio samples, when a sufficient number of samples is available to form said frame;
applying a frequency transformation to the audio samples of said frame.

13. The method according to claim 1, said method being suitable for the application of a smiling timbre to a voice, wherein said at least two frequencies of formants are frequencies of formants affected by the smiling timbre of a voice.

14. The method according to claim 13, characterized in that said increasing continuous transformation function of the frequencies of the spectral envelope has been determined during a training phase, by comparing spectral envelopes of phenomena stated by users, neutrally or while smiling.

15. The computer program product comprising program code instructions recorded on a computer-readable medium in order to carry out the steps of the method according to claim 1 when said program operates on a computer.
